(19) United States
(12) Patent Application Publication
(10) Pub. No.: US 2026/0183717 A1
(43) Pub. Date: Jul. 2, 2026

(54) MIXING HOLLOW FIBER SIZES FOR IMPROVED HUMIDIFIER PERFORMANCE

(71) Applicant: Parker-Hannifin Corporation, Cleveland, OH (US)

(72) Inventors: Sucharitha Rajendran, Nashua, NH (US); Leonard Castellano, Surf City, NC (US); John D. Holland, Lawrenceburg, TN (US)

(73) Assignee: Parker-Hannifin Corporation, Cleveland, OH (US)

(21) Appl. No.: 19/548,642

(22) Filed: Feb. 24, 2026

Related U.S. Application Data
(63) Continuation of application No. PCT/US2024/044100, filed on Aug. 28, 2024.
(60) Provisional application No. 63/535,140, filed on Aug. 29, 2023.
(60) Provisional application No. 63/683,754, filed on Aug. 16, 2024.

(51) Int. Cl. B01D 63/02; B01D 63/04; B01D 69/08; H01M 8/04119

(52) U.S. Cl. CPC B01D 63/033; B01D 63/032; B01D 63/046; B01D 69/081; H01M 8/04149; B01D 2313/44

(57) ABSTRACT

A fluid transfer element is provided that may be used as a humidifier in a fuel cell application to transfer moisture from wet discharge air to incoming dry air from ambient. The element comprises an arrangement of hollow membrane tubes, also referred to as hollow membrane fibers, which have a passageway through the tubes and a separate passageway around the tubes through interstices between adjacent exteriors of tubes. The arrangement of the hollow membrane tubes comprises tubes having different flow cross-section areas arranged to provide different flow restriction properties, which can be provide by larger diameter tubes and smaller diameter tubes. The tubes may be arranged to reduce pressure drop and induce wet gas air flow into smaller interstices along the wet air flow path.

### CROSS-REFERENCE TO RELATED PATENT APPLICATIONS

This Patent Application is a continuation of International PCT Application No. PCT/US2024/044100, filed Aug. 28, 2024, which is currently pending, the entire teachings and disclosure of which is incorporated herein by reference thereto. This Patent Application claims the benefit of U.S. Provisional Patent Application No. 63/683,754, filed Aug. 16, 2024, and U.S. Provisional Patent Application No. 63/535,140, filed Aug. 29, 2023, the entire teachings and disclosure of each of which are incorporated herein by reference thereto.

### FIELD OF THE INVENTION

This invention generally relates to fluid transfer devices which may be embodied as humidifiers for example, and more particularly relates to mixing hollow fiber sizes of such fluid transfer devices.

### BACKGROUND OF THE INVENTION

A humidifier plays a crucial role in optimizing the performance of a Hydrogen PEM fuel cell. It helps control the moisture content of the incoming reactant gases, such as hydrogen and air. By managing the humidity of the reactant gases, the humidifier ensures that the fuel cell operates at its best efficiency. Maintaining the proper moisture levels facilitates the ion conduction process in the fuel cell's electrolyte, promoting efficient electrochemical reactions. This ultimately leads to improved overall performance, power output, and longevity of the fuel cell.

One known type of humidifier with an annular filter filled with tubular membrane fibers is shown and described in WO2023028037 to Duryea entitled “Fuel Cell Humidificaton Potting Adhesive Shroud.” Duryea discloses a separation and/or humidification element that employs a single annular bundle of fibrous hollow membrane tubes, which may be used for water vapor transfer between different gas streams in a fuel cell application, such as to humidify the reaction gas. At least one and typically two composite end caps encapsulate ends of a bundle of the fibrous hollow membrane tubes. Each composite end cap comprises adhesive (e.g. epoxy) and a preform such as a plastic annular shroud.

Another different configuration of humidifier with a cylindrical bundle of tubular membrane fibers is shown in U.S. Pat. No. 8,317,167 to Kim entitled “Humidifier For Fuel Cell”. The '167 patent to Kim discloses a humidifier for a fuel cell, in which a plurality of hollow fiber membranes have different diameters that arranged to control the flow direction of dry air introduced into the humidifier. However, the arrangement of the '167 patent to Kim does not consider the effects of the wet air flow and in particular that it would appear more difficult for the wet air flow to reach the center of the cylindrical bundle of tubular membrane fibers with smaller diameter tubes.

### BRIEF SUMMARY OF THE INVENTION

The present application and embodiments thereof provides the potential to enhance humidity transfer at a low cost in overall restriction.

To increase humidity transfer while using hollow fiber membranes, one needs to increase the surface area of contact for exchange between the dry and wet side of the humidifier. To do this, increased number of fibers can be used for the same volume of flow, or smaller fibers can be used for the same volume of flow. Both of these have a high cost in terms of pressure either of the fiber side (e.g., dry air flow) or on the shell side of the humidifier (e.g., wet air flow). A solution provided herein to mix the fiber diameters used in the humidifier thus enabling a way to see a significant gain in humidity transfer, while only moderately increasing the pressure differential cost overall.

The following design allows for improved humidity transfer in a humidifier between the wet and dry side while costing little on the flow restriction. The design incorporates mixed hollow fiber diameters distributed throughout the humidifier to be able to increase capacity of humidification.

The flow going through the fiber side (e.g., dry flow) has pressure drop caused by the number of fibers and the inner diameters of the fibers. The flow going on the outside (shell side, e.g., wet air flow) has pressure drop caused by the number of fibers and the outer diameters of the fibers. The number of fibers and the diameters of the fibers dictate the available surface area for exchange of humidity and good humidity transfer. Instead of changing all the fiber diameters to increase surface area (and thus increase humidity transfer), one can mix fiber diameters appropriately in the humidifier to be able to get enhanced performance improvements.

In one embodiment, the humidifier includes a filter element (i.e., fluid transfer element) having a mass of tubular fibers arranged in an annular arrangement in parallel with the direction of fluid flow through the humidifier. The tubular fibers have at least two different fiber diameters and optionally can include at least three different fiber diameters.

The tubular fibers can be arranged in a circumferential sequence D1, D2, Dn . . . of different fiber diameters, or can be arranged in other groupings.

The fill volume of the humidifier can be equally divided between the different fiber sizes. For example, if the humidifier has a 32% fill ratio (fill volume=% of cross section that has fibers), with 2 fiber diameters, then there can be 16% of D1 fibers and 16% of D2 fibers.

In another embodiment, a fluid transfer element that can be separated into different collections of hollow membrane tubes that can be placed in parallel fluid circuit (e.g., fluid can flow through one collection or the other and need not flow through both as would be the case with serial fluid circuit). In this embodiment different collections have different average flow cross-section areas of the hollow membrane tubes.

In another embodiment, fluid transfer element can be separated into different collections of hollow membrane tubes by different cartridges that can employed together. In this embodiment different cartridges have collections different average flow cross-section areas of the hollow membrane tubes.

In accordance with an inventive aspect of the present invention, a fluid transfer element is provided comprising: an arrangement of hollow membrane tubes that has: (a) a first flow passageway defined through the hollow membrane tubes; and (b) a second flow passageway passing separately from the first flow passageway and passing though interstices defined between adjacent members of the hollow membrane tubes, with the second flow passageway passing between an inlet region and an outlet region. The arrangement of the hollow membrane tubes comprises tubes having different flow cross-section areas are arranged to provide different flow restriction properties with a first collection of the hollow membrane tubes having a smaller average flow cross-section area than a second collection of the hollow membrane tubes. The first collection of the hollow membrane tubes are arranged to be subject to a greater pressure drop along the second flow passageway than the second collection of the hollow membrane tubes.

Various features below (or above) may be used with the above inventive aspect either alone or in various combination(s) with each other.

It is a feature that the first collection of the hollow membrane tubes are also arranged to be subject to a greater pressure drop along the first flow passageway than the second collection of the hollow membrane tubes.

It is a feature that the fluid transfer element is incorporated into an assembly that further comprises a housing defining an element cavity that receives the fluid transfer element. The housing further comprises: a first pair of fluid ports with the first flow passageway arranged to flow therebetween, including a first inlet and a first outlet; a second pair of fluid ports with the second flow passageway arranged to flow therebetween including a second inlet and a second outlet, the second inlet communicating with the inlet region and the second outlet communicating with the outlet region.

In such assembly feature, the housing may comprise a housing body and a removable lid, with the lid being removable to allow for replacement of fluid transfer element.

In such assembly feature, the housing may comprise a rectangular box-shaped configuration having six sides defining the element cavity, wherein the first inlet and the first outlet are along a single common side of the six sides; and/or the second inlet and the second outlet are along a single common side of the six sides. Preferably, each of the first inlet, the first outlet, second inlet and the second outlet are along a single common side of the six sides.

It is a feature that the fluid transfer element may be broken up into separate cartridges including a first cartridge and a second cartridge in spaced apart relation. Each cartridge can have respective spaced apart first and second caps into which respective collections of the hollow membrane tubes are sealingly engaged. For example, the first cartridge can comprise the first collection of the hollow membrane tubes and the second cartridge can comprise the second collection of the hollow membrane tubes.

It is a feature according to an embodiment that the arrangement of the hollow membrane tubes surrounds a central open cavity. For example, the fluid transfer element can further comprise a pair of end caps on opposing ends of the arrangement, one of the end caps having an opening communicating with the central open cavity and wherein the second flow passageway extends radially between the central open cavity and an outer periphery around the arrangement.

In the above feature, the arrangement of hollow membrane can comprise sets of hollow membrane tubes having different flow cross-section areas including at least a first annular region and a second annular region.

In the arrangement of the above feature, the first annular region can be radially inside the second annular region with the hollow membrane tubes of the first annular region of a larger average flow cross-section area than the hollow membrane tubes of the second annular region. Optionally, this arrangement may yet further comprise a third annular region of the hollow membrane tubes radially outside of the second annular region, with the hollow membrane tubes of the third annular region being of a larger average flow cross-section area than the hollow membrane tubes of the second annular region.

In accordance with another inventive aspect of the present invention, a fluid transfer element is provided comprising: an arrangement of hollow membrane tubes that has: (a) a first flow passageway defined through the hollow membrane tubes; and (b) a second flow passageway passing separately from the first flow passageway and passing though interstices defined between adjacent members of the hollow membrane tubes, with the second flow passageway passing between an inlet region and an outlet region. Furthermore, the fluid transfer element may be provided by multiple cartridges including a first cartridge and a second cartridge in spaced apart relation. Each cartridge has respective spaced apart first and second caps into which respective collections of the hollow membrane tubes are sealingly engaged. The first cartridge comprises a first collection of the hollow membrane tubes and the second cartridge comprises a second collection of the hollow membrane tubes, with the first collection of the hollow membrane tubes having a smaller average flow cross-section area than a second collection of the hollow membrane tubes.

Various features below (or above) may be used with the above inventive aspect either alone or in various combination(s) with each other.

In the above aspect, preferably, the hollow membrane tubes of the first cartridge are all of a common size, and/or the hollow membrane tubes of the second cartridge are all of a common size, however, alternatively a mix of fibers of different sizes may be used in a cartridge.

In the above aspect, it is a feature that the first collection of the hollow membrane tubes are also arranged to be subject to a greater pressure drop along the first flow passageway than the second collection of the hollow membrane tubes.

In the above aspect, it is a feature that each cartridge has a sidewall with a window proximate each end cap communicating the second passageway therethrough.

In the above aspect, it is a feature that the multiple cartridges further includes a third cartridge in spaced relation to the first and second cartridges, with the second cartridge interposed between the first and third cartridges. The third cartridge comprises a third collection of the hollow membrane tubes, in that the third collection of the hollow membrane tubes has a larger average flow cross-section area than the first and second collections of the hollow membrane tubes.

In the above aspect, the fluid transfer element can be incorporated into an assembly further comprising a housing defining an element cavity receiving the fluid transfer element. The housing can comprise: a first pair of fluid ports with the first flow passageway arranged to flow therebetween, including a first inlet and a first outlet; and a second pair of fluid ports with the second flow passageway arranged to flow therebetween including a second inlet and a second outlet, the second inlet communicating with the inlet region and the second outlet communicating with the outlet region.

In such assembly feature, the housing may comprise a housing body and a removable lid, with the lid being removable to allow for replacement of fluid transfer element.

In such assembly feature, the housing may comprise a rectangular box-shaped configuration having six sides defining the element cavity, wherein the first inlet and the first outlet are along a single common side of the six sides; and/or the second inlet and the second outlet are along a single common side of the six sides. Preferably, each of the first inlet, the first outlet, second inlet and the second outlet are along a single common side of the six sides.

In accordance with another inventive aspect of the present invention, a fluid transfer element is provided comprising: an arrangement of hollow membrane tubes that has: (a) a first flow passageway defined through the hollow membrane tubes; and (b) a second flow passageway passing separately from the first flow passageway and passing though interstices defined between adjacent members of the hollow membrane tubes, with the second flow passageway passing between an inlet region and an outlet region. Further, the arrangement of the hollow membrane tubes comprises tubes having different flow cross-section areas with a first collection of the hollow membrane tubes and a second collection of the hollow membrane tubes, in which the first collection of the hollow membrane tubes has a smaller average flow cross-section area than a second collection of the hollow membrane tubes, and further with the first and second collection of the hollow membrane tubes being arranged in parallel fluid circuit along the second flow passageway.

Various features below (or above) may be used with the above inventive aspect either alone or in various combination(s) with each other.

In the above aspect, it is a feature that at least one partition wall is between the first and second collections of hollow membrane tubes.

In the above aspect, it is a feature that the fluid transfer element is provided by multiple cartridges including a first cartridge and a second cartridge. Each cartridge has respective spaced apart first and second caps into which respective collections of the hollow membrane tubes are sealingly engaged, with the first cartridge comprises the first collection of the hollow membrane tubes and the second cartridge comprises the second collection of the hollow membrane tubes.

In the above aspect, it is a feature that the first collection of the hollow membrane tubes are also arranged to be subject to a greater pressure drop along the first flow passageway than the second collection of the hollow membrane tubes.

In the above aspect, it is a feature that the second collection of the hollow membrane tubes are arranged to be further downstream along the second flow path relative to the first collection of the hollow membrane tubes.

In the above aspect, it is a feature that a third collection of the hollow membrane tubes is provide. The third collection of the hollow membrane tubes has a larger average flow cross-section area than the first and second collections of the hollow membrane tubes.

In the above feature, the third collection may be arranged in parallel fluid circuit with the first and second collections.

In the above aspect, the fluid transfer element can be incorporated into an assembly further comprising a housing defining an element cavity receiving the fluid transfer element. The housing can comprise: a first pair of fluid ports with the first flow passageway arranged to flow therebetween, including a first inlet and a first outlet; and a second pair of fluid ports with the second flow passageway arranged to flow therebetween including a second inlet and a second outlet, the second inlet communicating with the inlet region and the second outlet communicating with the outlet region.

In such assembly feature, the housing may comprise a housing body and a removable lid, with the lid being removable to allow for replacement of fluid transfer element.

In such assembly feature, the housing may comprise a rectangular box-shaped configuration having six sides defining the element cavity, wherein the first inlet and the first outlet are along a single common side of the six sides; and/or the second inlet and the second outlet are along a single common side of the six sides. Preferably, each of the first inlet, the first outlet, second inlet and the second outlet are along a single common side of the six sides.

In accordance with another inventive aspect of the present invention, a fluid transfer element is provided comprising: an arrangement of hollow membrane tubes that has: (a) a first flow passageway defined through the hollow membrane tubes; and (b) a second flow passageway passing separately from the first flow passageway and passing though interstices defined between adjacent members of the hollow membrane tubes, with the second flow passageway passing between an inlet region and an outlet region. Further, the arrangement of the hollow membrane tubes comprises tubes having different flow cross-section areas with a first collection of the hollow membrane tubes and a second collection of the hollow membrane tubes, the first collection of the hollow membrane tubes having a smaller average flow cross-section area than the second collection of the hollow membrane tubes, the first collection of the hollow membrane tubes being closer to the inlet region of the second flow passageway than the second collection.

Various features below (or above) may be used with the above inventive aspect either alone or in various combination(s) with each other.

In the above aspect, it is a feature that the first collection of the hollow membrane tubes are arranged to be subject to a greater pressure drop along the first flow passageway than the second collection of the hollow membrane tubes.

In the above aspect, the fluid transfer element can be incorporated into an assembly further comprising a housing defining an element cavity receiving the fluid transfer element. The housing can comprise: a first pair of fluid ports with the first flow passageway arranged to flow therebetween, including a first inlet and a first outlet; and a second pair of fluid ports with the second flow passageway arranged to flow therebetween including a second inlet and a second outlet, the second inlet communicating with the inlet region and the second outlet communicating with the outlet region.

In such assembly feature, the housing may comprise a housing body and a removable lid, with the lid being removable to allow for replacement of fluid transfer element.

In such assembly feature, the housing may comprise a rectangular box-shaped configuration having six sides defining the element cavity, wherein the first inlet and the first outlet are along a single common side of the six sides; and/or the second inlet and the second outlet are along a single common side of the six sides. Preferably, each of the first inlet, the first outlet, second inlet and the second outlet are along a single common side of the six sides.

In the above aspect, it is a feature that the fluid transfer element is broken up into separate cartridges including a first cartridge and a second cartridge in spaced apart relation. Each cartridge can have respective spaced apart first and second caps into which respective collections of the hollow membrane tubes are sealingly engaged. The first cartridge can comprise the first collection of the hollow membrane tubes and the second cartridge can comprise the second collection of the hollow membrane tubes.

In the above aspect, it is a feature that the arrangement of the hollow membrane tubes surrounds a central open cavity. The fluid transfer element can further comprise a pair of end caps on opposing ends of the arrangement, with one of the end caps having an opening communicating with the central open cavity. The second flow passageway can extend radially between the central open cavity and an outer periphery around the arrangement. The arrangement of hollow membrane comprises tubes having different flow cross-section areas including at least a first annular region and a second annular region.

In the above feature, the first annular region may be radially inside the second annular region with the hollow membrane tubes of the first annular region of a larger average flow cross-section area than the hollow membrane tubes of the second annular region.

In the either or both of the two above features, a third annular region of the hollow membrane tubes may be radially outside of the second annular region, with the hollow membrane tubes of the third annular region being of a larger average flow cross-section area than the hollow membrane tubes of the second annular region.

In accordance with another inventive of the present invention, a fluid transfer element comprises an arrangement of hollow membrane tubes in a ring configuration surrounding a central open cavity, with a pair of end caps on opposing ends of the arrangement. One of the end caps has an opening communicating with the central open cavity. A first flow passageway defined through the hollow membrane tubes; and a second flow passageway passes separately from the first flow passageway and is defined by interstices defined between adjacent members of the hollow membrane tubes. The second flow passageway passes radially between the central open cavity and an outer periphery around the arrangement. Further, the arrangement of the hollow membrane tubes comprises tubes having different flow cross-section areas.

Various features below (or above) may be used with the above inventive aspect either alone or in various combination(s) with each other.

The arrangement of the hollow membrane tubes includes a first collection of the hollow membrane tubes and a second collection of the hollow membrane tubes, the first collection of the hollow membrane tubes having a smaller average flow cross-section area than the second collection of the hollow membrane tubes.

In the above aspect, it is a feature that the arrangement of the hollow membrane tubes comprises a first annular region of the hollow membrane tubes having different average flow cross-section area than a second annular region of the hollow membrane tubes.

In the above feature, the first annular region may be radially inside the second annular region, with the first annular region having a first average flow cross-section area of the hollow membrane tubes that is larger than a second average flow cross-section area of the hollow membrane tubes of the second annular region.

The above feature may further comprise a third annular region of the hollow membrane tubes, with the third annular region radially outside of the second annular region. The third annular region may have a third average flow cross-section area of the hollow membrane tubes that is larger than the second average flow cross-section area.

Even more, the above feature may comprise a fourth annular region of the hollow membrane tubes, with the fourth annular region radially outside of the third annular region. The fourth annular region may have a fourth average flow cross-section area of the hollow membrane tubes that is smaller than the third average flow cross-section area.

In the above aspect, it is a feature that the first annular region provides an innermost region immediately surrounding the central cavity, and optionally a tubular support cage within the central cavity.

In the above aspect, it is a feature that the fluid transfer element is incorporated into an assembly that further comprises a housing defining an element cavity receiving the fluid transfer element. The housing further comprises: a first pair of fluid ports with the first flow passageway arranged to flow therebetween, including a first inlet and a first outlet; and a second pair of fluid ports with the second flow passageway arranged to flow therebetween including a second inlet and a second outlet. The second inlet communicates with an inlet region of the fluid transfer element and the second outlet communicates with an outlet region of the fluid transfer element. The inlet region is an annular chamber surrounding the outer periphery of the outermost annular region of the hollow membrane tubes or provided by the central open cavity.

Another inventive aspect that may employ one or more of the aspects and/or features above is that of a humidifier for a fuel cell, in which the humidifier includes a filter element (also referred to as fluid transfer element) having a mass of tubular fibers (e.g. hollow membrane tubes) arranged in parallel with the direction of fluid flow through the humidifier, with the tubular fibers having at least two different fiber diameters.

In the above humidifier aspect, the tubular fibers may include at least three different fiber diameters.

In the above humidifier aspect, the tubular fibers may be arranged in a circumferential sequence D1, D2, Dn . . . of different fiber diameters.

In the above humidifier aspect, the humidifier typically includes an annular mass of tubular fibers.

In the above humidifier aspect, the tubular fibers have at least two different internal fiber diameters.

In the above humidifier aspect, wherein the tubular fibers have at least two different external fiber diameters.

### Additional Features Useable In The Various Different Inventive Aspects

Additional features below (or above) may be used in any of the various different inventive aspects and features mentioned above either alone or in combination.

It is a feature that the fluid transfer element of further comprises first and second caps into which the hollow membrane tubes are sealingly engaged. Further, intermediate portions of the hollow membrane tubes between the first and second end caps are exposed to the second flow passageway.

It is a feature that the first collection of the hollow membrane tubes have a first average flow cross-section area that is between 10% and 80% of a second average flow cross-section area of the second collection of the hollow membrane tubes, and more preferably between 20% and 50% of the second average flow cross-section area of the second collection of the hollow membrane tubes.

It is a feature that the hollow membrane tubes define an inner diameter/width of less than 2 millimeters and preferably between 0.4 millimeter and 1.3 millimeter, and wherein the inner diameter/width of the second collection of the hollow membrane tubes is larger than the inner diameter/width of the first collection of the hollow membrane tubes by at least 0.1 millimeter and preferably between 0.2 millimeter and 0.8 millimeter.

It is a feature the hollow membrane tubes having different flow cross-section areas comprise at least three distinct sizes of the hollow membrane tubes.

It is a feature that preferably the hollow membrane tubes of the first collection are each of a first common size, and the hollow membrane tubes of the second collection are each of a second common size. Alternatively, hollow membrane tubes of different sizes can be mixed for each collection, in which the inner diameter/width for such collection is considered an average of such mix.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic flow diagram of a fuel cell circuit including a humidifier in accordance with an embodiment of the present invention;

FIG. 2 is an isometric view of fluid transfer assembly in a form of a humidifier in accordance with an embodiment of the present invention that may be use in the fuel cell circuit of FIG. 1;

FIG. 3 is a cross section of the humidifier such as shown in FIG. 2 to show the wet air flow into the humidifier along the second flow path in an embodiment with a fluid transfer element comprising two cartridges providing two collections of hollow membrane tubes of different fiber sizes;

FIG. 4 is a cross section of the humidifier such as shown in FIG. 2 to show the wet air flow (now partly dried) out of the humidifier along the second flow path using the fluid transfer element embodiment of FIG. 3.

FIG. 5 is a cross section of the humidifier such as shown in FIG. 2 to show the wet air flow into the humidifier along the second flow path in another embodiment similar to that of FIG. 3, but with a fluid transfer element comprising three cartridges providing three collections of hollow membrane tubes of different fiber sizes;

FIG. 6 is a cross section of the humidifier to show the wet air flow (now partly dried) out of the humidifier along the second flow path using the fluid transfer element embodiment of FIG. 5;

FIG. 7 is a mostly schematic cross-section illustration of the humidifier shown in FIG. 2, to show fluid flow therethrough;

FIG. 8 is mostly schematic cross-section illustration of the humidifier illustration of FIG. 7;

FIG. 9 is a perspective illustration of a fluid transfer element having two hollow fiber membrane bundles and cartridges;

FIG. 10 is an isometric view of a fluid transfer element having collections of hollow membrane tubes of different sizes in annular configurations according to another embodiment of the present invention;

FIG. 11 is an end view of the fluid transfer element shown in FIG. 10;

FIG. 12 is a partly schematic view of a cross section of fluid transfer element shown in FIG. 10 as installed in a housing to provide a humidifier assembly that may be used in the fuel cell circuit of FIG. 1;

FIG. 13 is an isometric illustration of part of a collection of larger hollow membrane fiber tubes useable in any of the embodiments of 1-12; and

FIG. 14 is an illustration of part of a collection of smaller hollow membrane fiber tubes useable in any of the embodiments of 1-12;

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

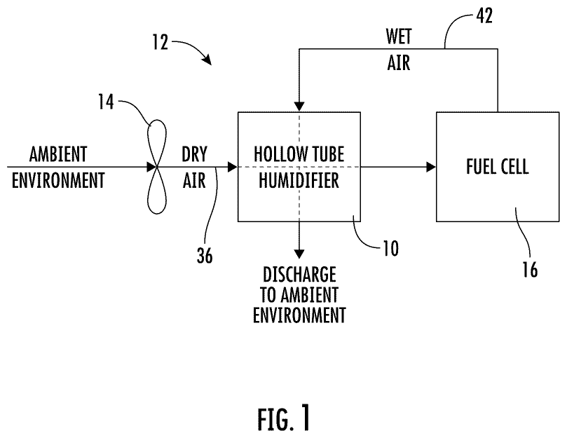

Referring to FIG. 1, an example of an operating environment is provided in the form of a hollow membrane fiber humidifier 10 in a fuel cell system 12, in accordance with an embodiment of the present invention. Fuel cell system 12 includes an air supply for the humidifier 10 in which dry air (e.g., ambient) is conveyed from an external environment by a blower 14, and exhaust gas containing wet air is discharged by a fuel cell 16. The wet air discharged by the fuel cell 16 passes through the humidifier 10, whereby the dry intake air for the fuel cell 10 is humidified by water contained in the fuel cell discharge gas (i.e., wet air) while passing through hollow membrane fiber tubes (shown in later figures) of the humidifier 10.

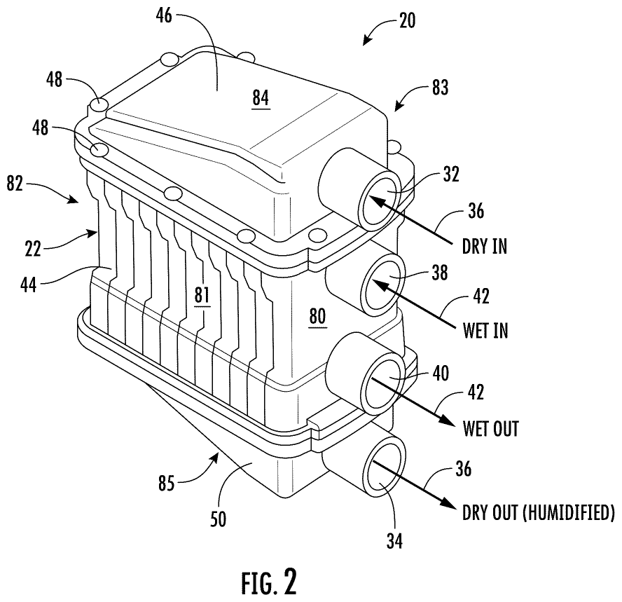

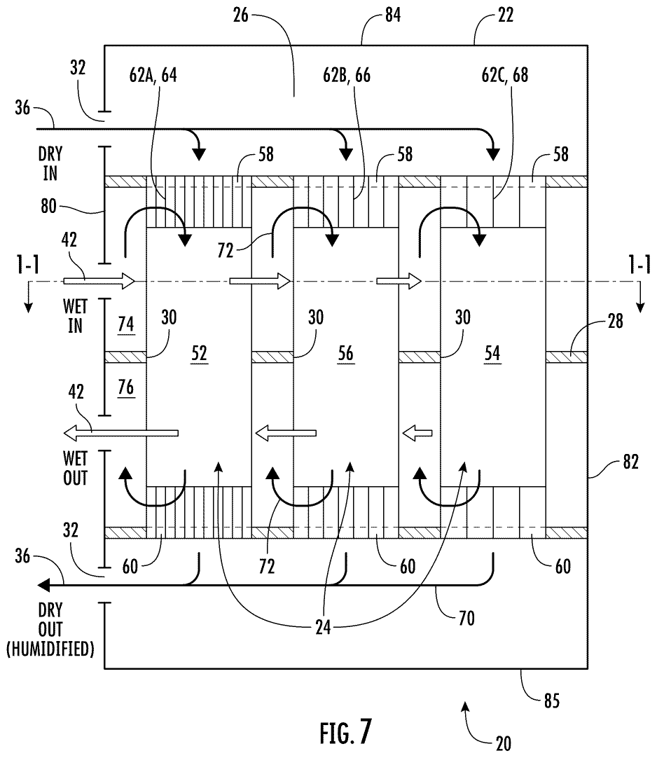

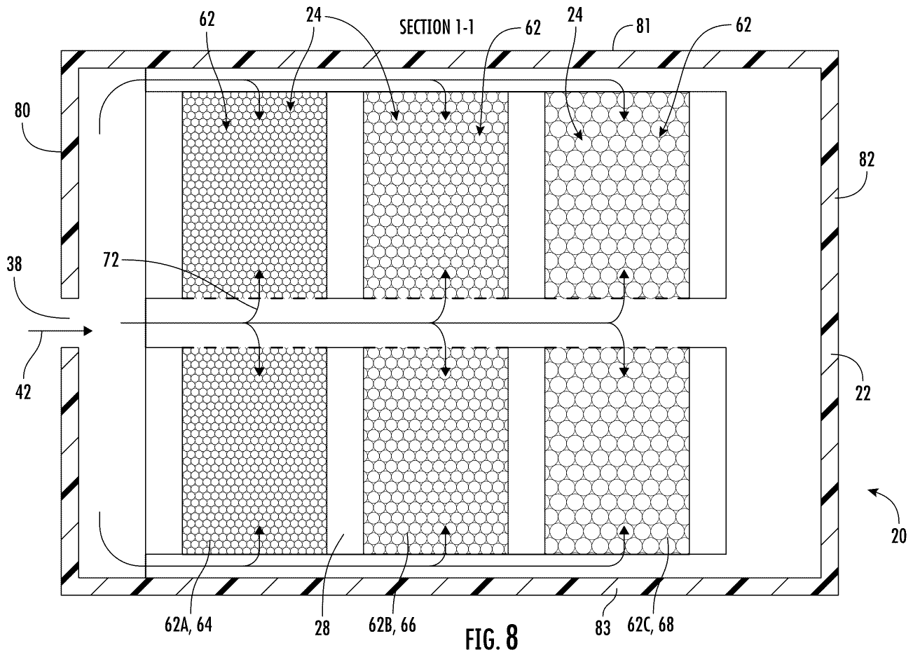

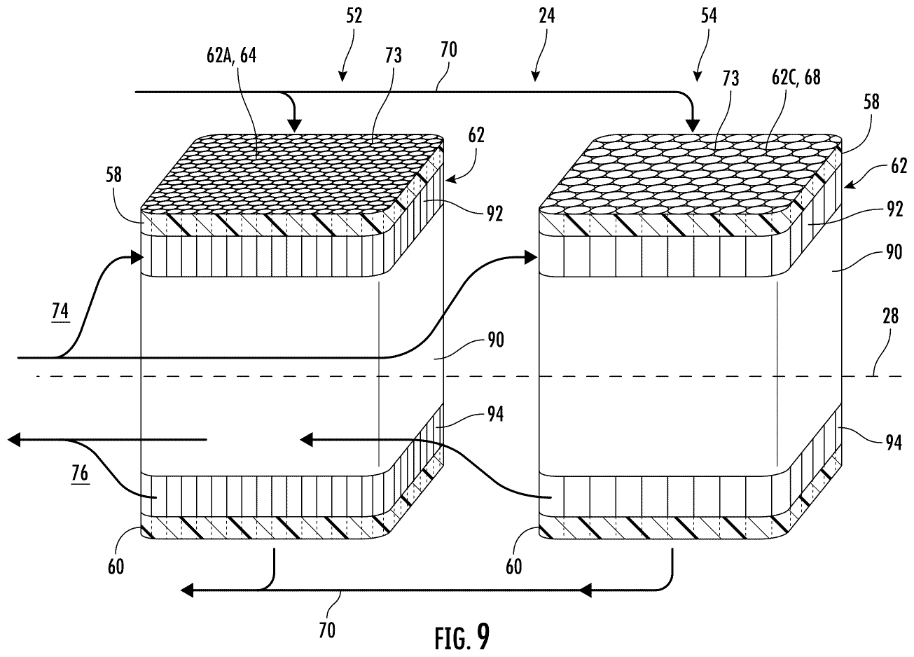

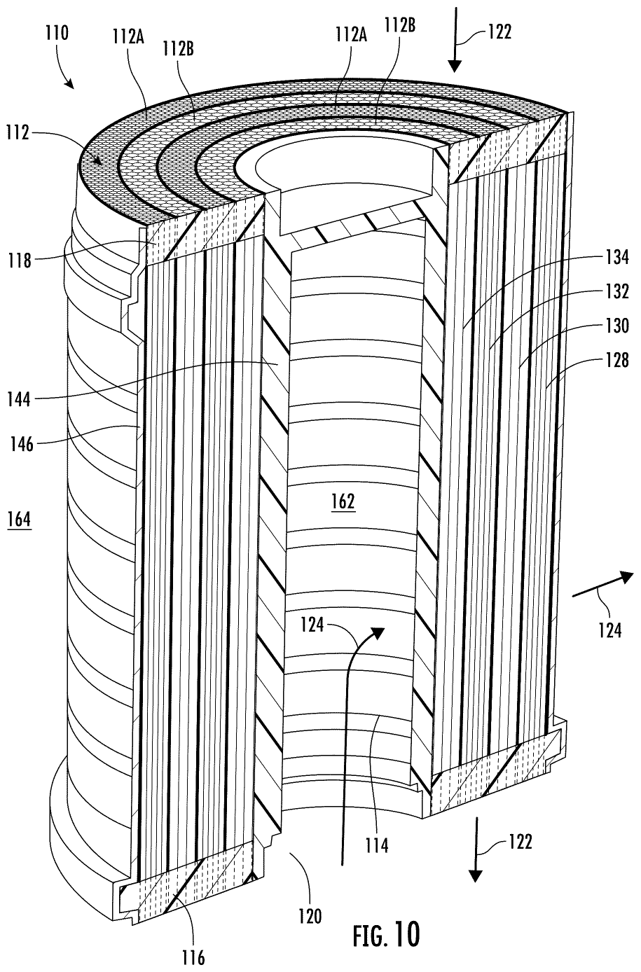

Turning to FIG. 2 (and FIGS. 3-8), an embodiment of a fluid transfer assembly 20 is illustrated which includes a housing 22 for a fluid transfer element 24 (i.e., the assembled collection of hollow membrane tubes such as shown in FIG. 9). The housing 22 defines an element cavity 24 which optionally may be divided by a partition such as a tube sheet 28 with cartridge openings 30. In any event, the element cavity 24 receives the fluid transfer element 24.

The fluid transfer assembly 20 can be used as the humidifier 10 as shown in FIG. 1 to increase humidity of the intake air leading to the fuel cell 16. However, it is appreciated that the fluid transfer assembly 20 can be used in other applications to transfer water and/or other select gases or other fluids as between different fluid streams.

Returning to FIG. 2 (and FIGS. 3-8), the housing 20 comprises a first pair of fluid ports 32, 34 with a first passageway 36 arranged to flow therebetween. In particular the ports include including an inlet port 32, for example for dry air intake from ambient as shown in FIG. 1, and an outlet port 34; for example, for now humified dry air that can be ported to the fuel cell as shown in FIG. 1.

Additionally, the housing comprises a second pair of fluid ports 38, 40 with the second flow passageway 42 arranged to flow therebetween. In particular the ports include including an inlet port 38, for example for receiving wet discharge gas from the fuel cell 16 shown in FIG. 1, and an outlet port 40, for example for discharging the wet discharge gas (with decreased water vapor due to humidification of the dry air) after having passed through the housing 20.

While the fluid transfer element 24 can be permanently mounted in the housing 22 (e.g., permanently bonded with adhesive directly to the housing 22), more preferably, the fluid transfer element 22 is replaceable so that if the porosity thereof becomes more restrictive due to contaminants, then the housing can be reused and the fluid transfer element 22 can be replaced.

To accomplish this, the housing 22 can comprises a housing body 44 and a removable lid 46. The lid 46 is removable (e.g., by fasteners 48 such as bolts or clamps to the housing body 44) to allow for replacement of fluid transfer element 24.

At the other end of the housing body 44, an end cover 50 is provided that may optionally be removable.

In this embodiment, the fluid transfer element 22 may be broken up into separate cartridges 52, 54, 56 that can be arranged in spaced apart relation as shown with gaps therebetween, each fitting one of the openings of the partition 28.

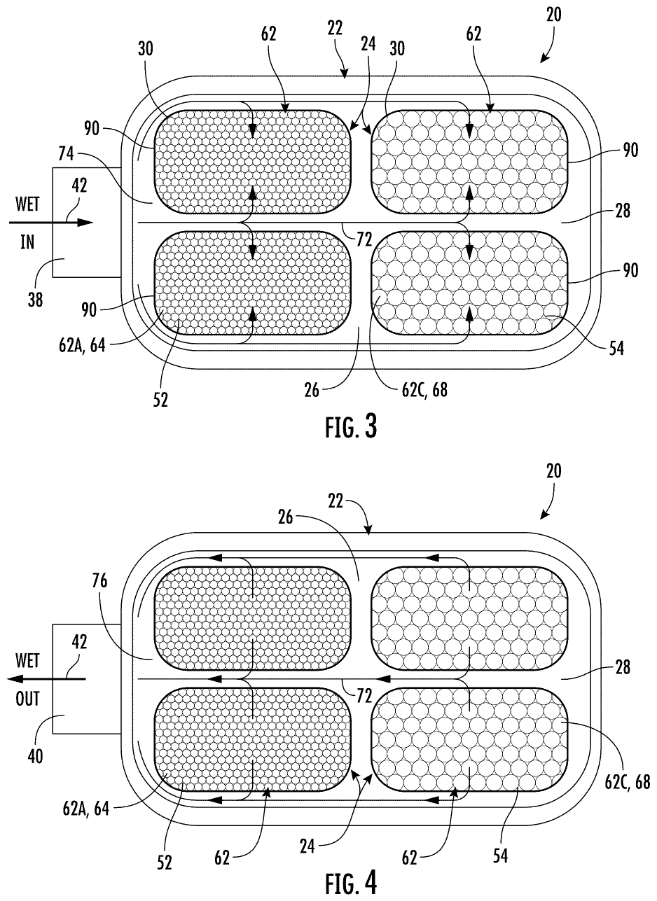

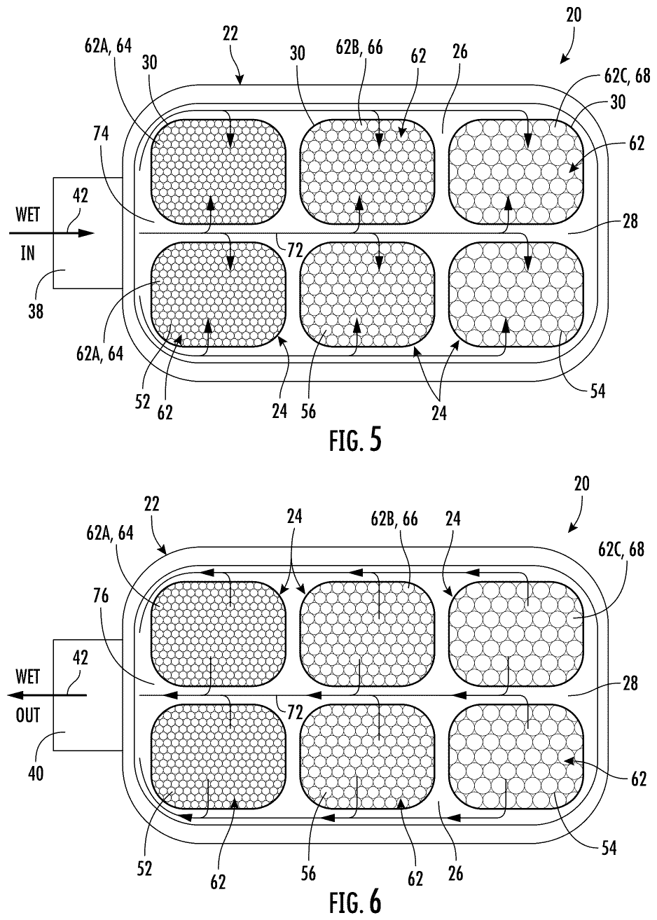

In FIGS. 3 and 4, two cartridges 52, 54 are provided, whereas in FIGS. 5 and 6 three cartridges 52, 54, 56 are provided. Additionally or alternatively each individual cartridge could be divided into separate cartridges side-by-side fitting a single opening (e.g., for example if a single cartridge 52 had divider partitions therein to effectively create multiple cartridges within such cartridge 52).

Each cartridge 52, 54, 56 has respective spaced apart first and second caps 58, 60 into which respective collections of hollow membrane tubes 62 are sealingly engaged. For example, each end cap 58, 60 can comprise polyurethane or epoxy into which ends of the hollow membrane tubes 62 are potted/molded with the ends being cut, and optionally with a shroud retainer, which process is discussed and illustrated further for example in WO2023/028037 to Duryea, the entire disclosure of which is hereby incorporated by reference.

For example, the hollow membrane tubes 62 can comprises hollow polymer fibers comprising a length of between 3 inches and 3 feet (corresponding to the length of an element 10). Suitable hollow membrane tubes 62 (e.g., hollow membrane fibers) useable in any of the foregoing embodiments are generally known in the art as may exemplified by: U.S. Patent Publication No. 2010/0190093 to Lee, which discloses hollow fiber membranes having a tube-type first hydrophilic polymer film having a hollow center, and a second hydrophilic polymer film coated on the inner surface of the tube-type first hydrophilic polymer film (for example, U.S. Patent Publication No. 2010/0190093 to Lee discloses that the tubes may have one or two films (preferrably two films) and comprising fiber membrane material that can produced from poly etherimide (PEI), polyimide (PI), polyamideimide (PAI), polysulfone or poly ethersulfone, a perfluorinated sulfonic acid copolymer, polyvinylalcohol (PVA) or polyacrylonitrile (PAN)); and/or by U.S. Publication No. 2008/0067700 to Korytnikov et al. which discloses hollow fibers, having water-permeable and micro-pores structure and are fabricated from polysulfone, polycarbonate, polyamide, and the like, adaptable to exchange humidity between two fluid streams, i.e. gas to gas or liquid to gas (the water permeability of the membrane being not higher than 10 ml/hr/mmHg to minimize the leakage of water carrier (DI water, humid gas) into the gas stream subject for the humidification); and/or those commercially available as indicated by U.S. Pat. No. 8,181,943 to Leister et. al. and/or Vaperma Siftek Technology (see https://www.greencarcongress.com/2009/03/uop-- to-offer-vahtml and EP 1,651,332 to Cranford et al./Vaperma, Inc). Accordingly, the patent publications in this paragraph are incorporated by reference in their entirety as the membrane materials disclosed therein are usable in embodiments of the hollow membrane tubes 62 of the present disclosure.

Suitable adhesive useable in any of the foregoing embodiments for the end caps 58, 60 include but are not limited to various epoxies including two part epoxies, and various types of polyurethane or other such adhesives that may be applied in flowable viscous liquid form and cure-in-place. The end cap adhesive being applied in a flowable viscous liquid form will typically fill the interstices between the adjacent tubes 62 to cause all or most of the fluid stream through the opposite open ends of the hollow membrane tubes 62, sufficient to cause the desired effect of moisture separation and exchange purposes. Once the adhesive for the end caps 58, 60 is cured, then the ends can be cut to expose the open ends of the hollow membrane tubes 62 such that fluid can travel through the tubes.

In these embodiments, first cartridge 52 comprises a first collection 64 of the hollow membrane tubes 62, and the second cartridge 54 comprises a second collection 68 of the hollow membrane tubes 62, and the optional third cartridge 56 if used provides a third collection 66 of the hollow membrane tubes 62.

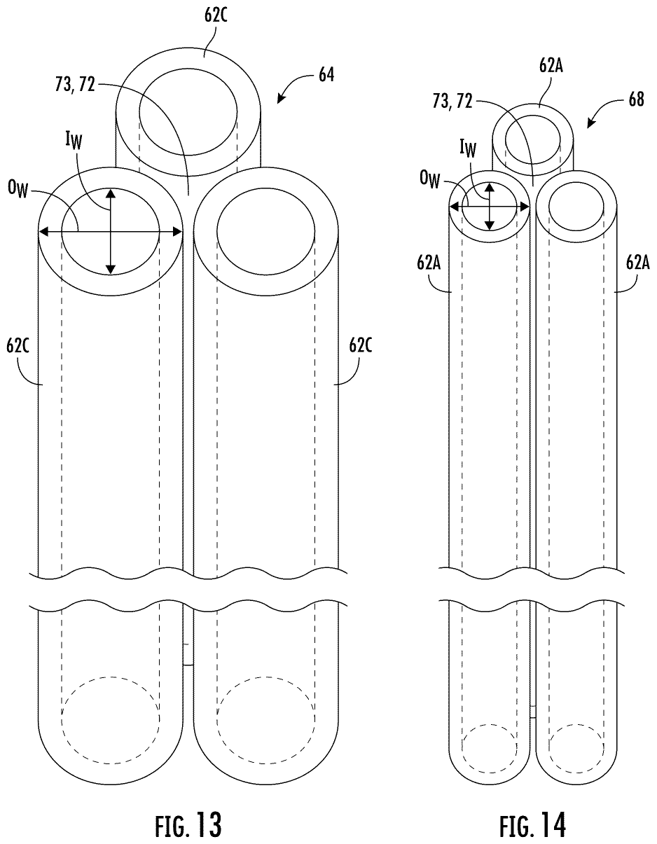

As shown in FIGS. 3-9, the fluid transfer element 20 provides an arrangement of the hollow membrane tubes 62 that has a first flow passageway 70 defined through the hollow membrane tubes 62; and a second flow passageway 72 passing separately from the first flow passage 70 and defined by interstices 73 (best shown in FIGS. 13-14) defined between adjacent members of the hollow membrane tubes 62. The second flow passageway 72, generally passes between an inlet region 74 and an outlet region 76.

When installed into an application, for example the housing 22, the first flow passageway 70 can be interposed along and form part of the housing intake flow passageway 36 (e.g., for the humidification of dry air), and the second flow passageway 72 can be interposed along and form part of the housing exhaust discharge flow passageway 42 (e.g., for scavenging moisture for wet air). The inlet region 74 and the outlet region 76 of the fluid transfer element 20 when in the housing 22 are fluidically in communication with the wet inlet port 38 and the wet outlet port 40, respectively as shown.

To facilitate the second wet flow passageway 72, and as shown best in FIG. 9, the cartridges 52, 54, 56 each include a sidewall 90 (sidewall 90 also numbered in FIG. 3 to show fitting into cartridge opening 30 in partition 28). As shown in FIG. 9, the sidewall 90 provides a central section to cartridge that is preferably impermeable and causes the wetter air flow to pass more or less the entire length of the hollow membrane tubes 62, with the sidewall 90 providing a wet inlet opening 92 proximate one end cap 58 and a wet outlet opening 94 proximate the other end cap 60.

As shown in FIG. 9, the wet inlet opening 92 may be provided by a single window (e.g., an annular gap between the sidewall 90 and the end cap 58) that extends around the entire perimeter of the respective cartridge. However, the sidewall 90 can also extend to and be embedded into the end cap 58, and the wet inlet opening 92 may be provided by one or more windows formed into the sidewall that do not extend the entire perimeter; for example, two window openings can be provided on opposite front/back sides or two windows openings can be provides on opposite lateral sides, or four window openings can be provided, for example a window for each of the four sides of the cartridge. Similar at the outlet side as shown in FIG. 9, the wet outlet opening 94 may be provided by a single window (e.g., an annular gap between the sidewall 90 and the end cap 60) that extends around the entire perimeter of the respective cartridge. However, the sidewall 90 can also extend to and be embedded into the end cap 60, and the wet outlet opening 94 may be provided by one or more windows formed into the sidewall that do not extend the entire perimeter; for example, two window openings can be provided on opposite front/back sides or two windows openings can be provides on opposite lateral sides, or four window openings can be provided, for example a window for each of the four sides of the cartridge.

As also illustrated, the arrangement of hollow membrane tubes 62 comprises tubes having different flow cross-section areas arranged to provide different flow restriction properties. This includes the first collection 64 of the hollow membrane tubes having a smaller average flow cross-section area than the second collection 68 of the hollow membrane tubes. And as shown for some embodiments, optionally more collections such as a third collection 66 of the membrane tubes that have average flow cross-section area different from that of the first or second collection 68.

Different average flow cross-section area can be done by simply by groupings of the hollow membrane tubes 62 that have different widths/diameters as shown such as with small diameter tubes 62A, large diameter tubes 62C and optionally intermediate diameter tubes 62B; or alternatively such collections and groupings may also be accomplished by mixing different amounts of hollow membrane tubes 62 of such different widths/diameters (e.g. one collection could have a mixture of 20% larger fiber tubes 62C and 80% smaller fiber tubes 62A; and another collection could have a mixture of 80% larger fiber tubes 62C and 20% smaller fiber tubes 62A). In these types of hollow membrane tubes, it is assumed/presumed in the art that the tubes are typically round and thus have an average diameter (or average width). Even if not perfectly cylindrical, such hollow membrane tubes 62 are considered to have a diameter as will be understood in the art (also may be referred to as width).

For example, FIGS. 13-14 are illustrative to show dimensions IW and OW for inner width/diameter and outer width/diameter, respectively, for hollow membrane tube fibers 62. Typically, for the various hollow membrane tubes 62 of different sizes (62A, 62B, 62C), the inner diameter IW for individual hollow membrane tubes 62 will be under 2 millimeters, and preferably and more typically between 0.4 millimeter and 1.3 millimeter.

Typically, the wall thickness of the individual hollow membrane tubes 62, regardless of size is relatively thin and not more than 0.2 millimeter, and typically 0.1 millimeter for most tubes in embodiments (e.g., wall thickness between 0.05 and 0.15 millimeter), but the range for wall thickness preferably may be selected to be between 0.15 millimeter and 1.5 millimeter which wall thickness can affect gas interaction between flow passageways 70, 72 to allow residence time for water vapor within the fiber of hollow membrane tubes 62 to transfer between the passageways. Therefore, for example, if wall thickness were 0.1 millimeter, outer diameter/width OW minus inner diameter/width IW is then calculated to be 0.2 millimeter. The inner diameter/width IW is referenced herein more than the outer diameter/width OW, as the inner diameter/width IW determines the available cross area flow.

The hollow membrane tubes 62 may be selected with different flow cross-section areas to comprise provided by smaller and larger tubes, with larger tubes 62C have an inner diameter/width IW that is at least 0.1 millimeter larger than an inner diameter/width IW smaller tubes 62A. Typically, the larger tubes 62C have an inner diameter/width IW that is at least between 0.2-0.8 millimeter larger than an inner diameter/width IW smaller tubes 62A. If used, intermediate tubes 62B may be of an inner diameter/width IW size that is intermediate (and preferably differentiated by 0.1-0.4 millimeters from that of the smaller tubes and differentiated by 0.1-0.4 millimeters from that of larger tubes).

For example, different embodiments may select the smaller tubes 62A to be used to have an inner diameter/width IW of between 0.4 to 0.7 millimeter, whereas the larger tubes 62C could have an inner diameter/width IW of between 0.7 and 1.3 millimeter, and even higher up to 1.7 millimeter in some examples. Additionally, sizes of intermediate membrane tubes 62B between the smaller tubes and the larger tubes may be used. Also, while homogeneous collections of same common sized tubes for different collections are shown, optionally a mixture of different sizes for different collections can be done. In this regard, the collection of hollow membrane tubes, could be said an average cross section area for all the large tubes and all the small tubes in a given setup.

Using tubes of different sizes (whether in homogeneous sized collections or collections having selectively different sizes) selectively can create substantially different cross area flow and thereby different restriction and pressure drop characteristics at different locations demonstrated by the table below for more typical sizes of tubes that may be employed in embodiments.

TABLE 1
TYPICAL SIZED TUBES TO BE SELECTED
FROM FOR COLLECTIONS OF TUBES

| Fiber | | Fiber | Fiber Tube Flow | Solid Fiber |
|---|---|---|---|---|
| Tube | | Tube | Cross-Section | Cross-Area |
| Inner | Wall | Outer | Area (square | (for 1 |
| Diameter- | Thickness | Diameter - | millimeters − πR²; | millimeter wall |
| IW (mm) | (mm) | OW (mm) | where R = ½ IW) | thickness) |
| 0.4 | 0.1 | 0.6 | 0.13 | 0.16 |
| 0.5 | 0.1 | 0.7 | 0.20 | 0.19 |
| 0.6 | 0.1 | 0.8 | 0.28 | 0.22 |
| 0.7 | 0.1 | 0.9 | 0.38 | 0.25 |
| 0.8 | 0.1 | 1.0 | 0.50 | 0.28 |
| 0.9 | 0.1 | 1.1 | 0.64 | 0.31 |
| 1.0 | 0.1 | 1.2 | 0.79 | 0.35 |
| 1.1 | 0.1 | 1.3 | 0.95 | 0.38 |
| 1.2 | 0.1 | 1.4 | 1.1 | 0.41 |
| 1.3 | 0.1 | 1.5 | 1.3 | 0.44 |
| 1.4 | 0.1 | 1.6 | 1.5 | 0.47 |
| 1.5 | 0.1 | 1.7 | 1.8 | 0.50 |
| 1.6 | 0.1 | 1.8 | 2.0 | 0.53 |
| 1.7 | 0.1 | 1.9 | 2.3 | 0.57 |

In the above table, there is the available flow area through the void hollow area of the tube (column four), and also the ability for interaction between the different flow paths that occurs within the fiber thickness of the tube (i.e., the thickness of the fiber membrane), which affects the transfer efficiency for humidity between the wet and dry flow passageways 70, 72. However, for embodiments, it is contemplated that wall thickness may also be varied, for example demonstrated in Table 2 below. And for different groupings of fibers used in an embodiment, different fibers may employ different wall thicknesses. Regardless, the outer width/diameter OW is quite closely correlated to the inner width/diameter IW by the wall thickness, so reference to the inner width/diameter IW is a useful parameter for both considerations of the resistance/pressure drop along both wet and dry passageways 70,72.

TABLE 2
VARIATION OF FIBER THICKNESS

| ID | Tube Wall | OD | | |
|---|---|---|---|---|
| (mm) | Thickness | (mm) | Tube Flow | Fiber c/s Area |
| IW | (mm) | OW | area (mm²) | (mm²) |
| 0.5 | 0.015 | 0.53 | 0.20 | 0.02 |
| 0.5 | 0.15 | 0.8 | 0.20 | 0.31 |
| 1.7 | 0.015 | 1.73 | 2.27 | 0.08 |
| 1.7 | 0.15 | 2 | 2.27 | 0.87 |

With these possibilities and depending upon what tubes are selected for smallest or largest inner diameters (IW), and as demonstrated by flow area in the chart above, typically the first collection 64 of hollow membrane tubes 62a have a first average flow cross-section area (demonstrated by column 4 “Fiber Tube Flow Cross-Section Area” in Table 1) that is typically between 5% and 80% of a second average flow cross-section area of the second collection 68 of the hollow membrane tubes 62c, and even more typically between 20% and 50% of a second average flow cross-section area of the second collection 68 of the hollow membrane tubes 62c. While the illustrated embodiments show collections of tubes having common size tubes, mixtures of tubes of different sizes could be used for the first collection 64 of smaller average flow cross-section area and mixtures of tubes of different sizes could be used for the second collection 68 of larger average flow cross-section area, but still typically within these range comparisons for flow cross-section area.

As discussed above and as shown in FIGS. 3-9, the collections 64, 66, 68 can be arranged in different spaced apart cartridges 52, 54, 56, with each cartridge having tubes of a common diameter/width as shown. Alternatively, and not shown, different collections 64, 66, 68 may also be grouped together rather than spaced such as with dividers for example put into one or more of the cartridges 52, 54, 56, and in which that can create additional cartridges within one or more of the illustrated cartridges.

Preferably, as shown, the tubes 62A of the first collection 64 are each of a first common size, and the tubes 62B of the second collection 66 are each of a second common size, and if employed, the tubes 62C of the third collection 68 are each of a third common size.

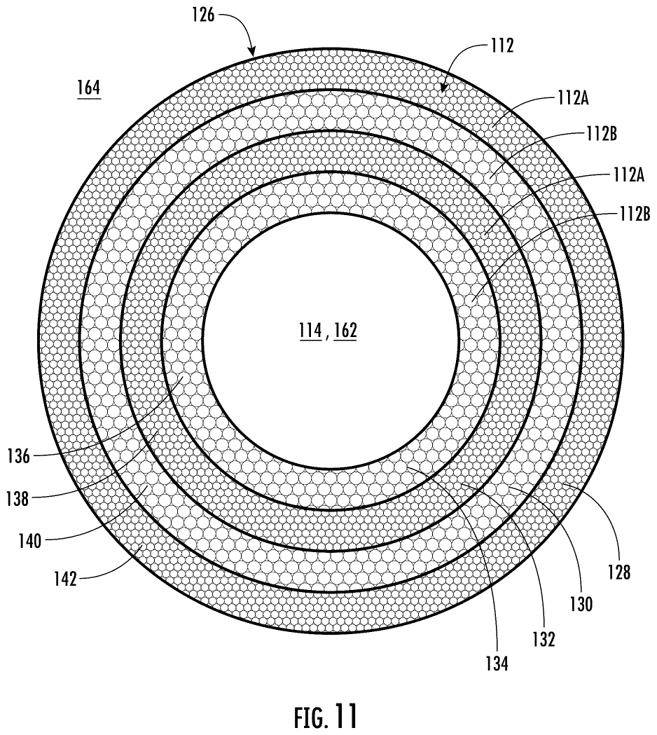

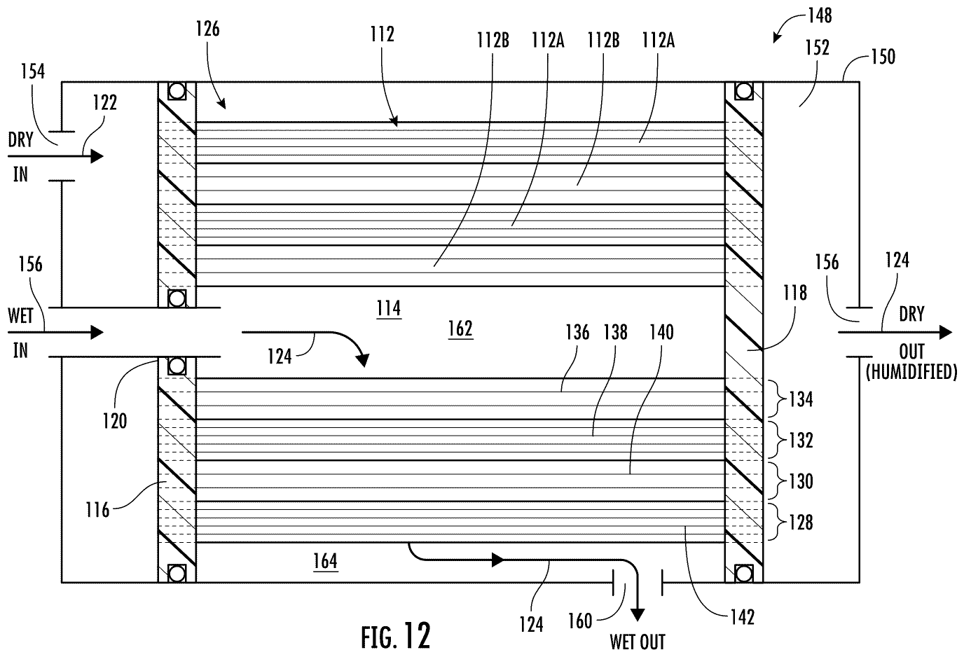

The use of different sizes of hollow membrane tubes 62 can be created several advantages in different configurations such as that shown in the present embodiment of FIG. 2-9, and also other embodiments such as in FIGS. 10-12. This provides for several different features as will be discussed in the below paragraphs, which features may be realized alone in an embodiment and/or in combination with another or multiple of the features in other embodiments.

One feature that may be realized is that mixing fiber sizes can increase pressure drops on shell (e.g. second passageway 42) and fibers (e.g., first passageway 36), but such mixing and arranging can create a way to optimize the fiber sizes to get a larger improvement in moisture transfer efficiency for a small pressure differential cost. The present application also considers effectively pressure drop and fluid flow of the wet flow to feature in an embodiment that even smaller fibers are subject to greater flow or positioned with greater pressure differential for increased flow. Stated another way, smaller fibers can be positioned in locations where the wet air flow is anticipated to be higher velocity (high pressure drop potential) and also preferably where the dry air flow is anticipated to be higher velocity and/or higher pressure drop potential).

Thus, a feature is that a collection 64 of smaller hollow membrane tubes 62A (e.g., with smaller average cross sectional flow areas) are arranged to be subject to a greater pressure drop along the second flow passageway 72 (e.g., wet flow between interstices 73-FIGS. 13-14) than either or both of the other collection(s) 66, 68 of larger hollow membrane tubes 62B, 62C.

Another further feature is that the first collection 60 of smaller hollow membrane tubes 62A are also arranged to be subject to a greater pressure drop along the first flow passageway 70 (e.g., dry flow through tubes to be humidified) than either or both of the other collection(s) 66, 68 of larger hollow membrane tubes 62B, 62C.

Another feature is that two or more of the collections 64, 66, 68 of hollow membrane tubes 62 are arranged in parallel fluid circuit along the second flow passage 72 (e.g. between interstices among fibers) such as shown in FIG. 3-9 (see also FIGS. 13-14 showing interstices 73 for second flow passageway 72). By parallel fluid circuit the fluid can alternatively flow pass alternatively through the interstices one or the other of the collections 64, 66, 68 but is not forced to serially flow through the interstices of different collections in sequence.

Elaborating further on the above parallel fluid arrangement feature, this feature can avoids creating compounding of pressure drop and restriction and is exemplified by the embodiment of FIG. 3-9 (but such feature is not used in the illustrated embodiment of FIGS. 10-12). For example, if wet air flow had to travel through multiple collections the interstices in FIGS. 2-9, then a stacking of restrictions occurs creating more pressure drop and lower velocity. This is avoided and allows the designer more options to select groupings of fibers and fibers sizes for efficiency, flow velocities and pressure differential (and can impact such this as energy inputs or energy availability for generating fluid flows). Furthermore, two or more of the collections 64, 66, 68 of hollow membrane tubes 62 are also arranged in parallel fluid circuit along the first flow passage 70 such as shown in FIG. 3-9, so that the fluid flow through the tubes is also in parallel fluid circuit (e.g., incoming dry air flow may only flow through individuals ones of the tubes and not multiple tubes in series).

Another feature exemplified in FIGS. 2-9 is the element is provided by multiple (e.g., two or more) cartridges 52, 54, 56 in spaced apart relation. Different cartridges 52, 54, 56 allow different configurations to be accomplished as each may comprise different collections of membrane tubes 62 having different average flow cross-section area. For example, in the illustrated embodiment, the first collection 64 of the hollow membrane tubes 62A has a smaller average flow cross-section area than a second collection 68 of the hollow membrane tubes 62C, and optionally one or more intermediate sized collection(s) 64 of the hollow membrane tubes 62B can be employed.

An arrangement feature is provided that one can arrange different sets of membrane tubes in regions where higher flow and/or higher pressure differential is expected. For example, a first collection 64 (e.g., of smaller tubes 64A) can be arranged closer to the inlet region 74 of the second flow passageway 72 (e.g. for wet flow) than a second collection 68 (e.g. of larger tubes 62C).

Returning to discussion and yet further observations regarding the illustrated embodiment of FIGS. 2-9, in these embodiments, the housing 22 preferably comprises a rectangular box-shaped configuration having six sides 80-85 defining the element cavity 26. In this embodiment the dry inlet port 32 and the dry outlet port 34 are along a single common side 80 of the six sides. Also, the wet inlet port 38 and the wet outlet port 40 can also be along a single common size 80, which may be the same side as that of the dry inlet and outlet pots 32, 34. This provides hookups all in one location, albeit porting could be along other walls and/or divided among different walls in other embodiments.

To show that different sizes of fiber arrangements can be employed in other arrangements and that may also accomplish one or more of the above features (other than the parallel circuit feature for wet/2^{nd} passageway), a further embodiment is shown in FIGS. 10-12.

Referring to FIGS. 10-12, a fluid transfer element 110 is illustrated in accordance with a further embodiment, comprising: an arrangement of hollow membrane tubes 112 in a ring configuration surrounding a central open cavity 114. A pair of end caps (e.g. open end cap 116 and closed end cap 118) are on opposing ends of the arrangement of hollow membrane tubes 112, with at least one of the end caps 116 having an opening 120 communicating fluid into the central open cavity 114.

Furthermore, a first flow passageway 122 (e.g. for dry air flow to be humidified as in FIG. 1) is defined through the hollow membrane tubes 112; and a second flow passageway 124 passes separately from the first flow passageway 122 and is defined by interstices defined between adjacent members of the hollow membrane tubes 112 (stated a different way would be around the external/peripheries of the tubes). The second flow passageway 124 in this embodiment passes radially between the central open cavity 114 and an outer periphery 126 around the arrangement (e.g., an outer periphery ring-shaped chamber). Furthermore, as shown this arrangement of the hollow membrane tubes 112 comprises tubes 112A and 112B having different flow cross-section areas.

Furthermore, in this embodiment, the arrangement of the hollow membrane tubes 112 includes a first collection 128 of the smaller hollow membrane tubes 112A and a second collection 130 of the larger hollow membrane tubes 112B. In this manner, this embodiment accomplishes a feature that the first collection 128 of hollow membrane tubes 112 have a smaller average flow cross-section area than the second collection 130 of the hollow membrane tubes 112.

Further, this embodiment may similarly feature a third collection 132 of smaller tubes 112A and/or a fourth collection 134 of larger tubes 112B.

In the fluid transfer element 110, the arrangement of the hollow membrane tubes 112 comprises an innermost annular region 136 of the hollow membrane tubes having a different average flow cross-section area than a different annular region 138 of the hollow membrane tubes. Multiple annular regions may be provided including an additional intermediate annular region 140, and an outermost region 140. How these are arranged size-wise for tube selection may depend on whether wet fluid flow is radially outward or radially inward.

In the embodiment shown, assuming radially outward flow (i.e., flow from cavity 114 to outer peripheral chamber 126), innermost annular region 136 has a first average flow cross-section area of the hollow membrane tubes 112 that is larger than a second average flow cross-section area of the hollow membrane tubes 112 of another surrounding region 138.

In this arrangement, the immediate flow area proximate the cavity 114 is limited and has larger interstices at this location that should be advantageous to promote flow toward the surrounding region 138 where transfer efficiency of moisture should be higher due to higher surface fiber area.

Further regions may be provided in stratification as shown, to limit the effects of restriction and provide areas of larger regions to allow release of the wet flow. Thus, a third intermediate annular region 140 of the hollow membrane tubes 112, with the third annular region radially outside of the second annular region 138. As shown, the third annular region 140 has a third average flow cross-section area of the hollow membrane tubes that is larger than the second average flow cross-section area of the second annular region 138.

This design also tries to accomplish a further efficient transfer where a lot of interstices occur at the outermost region whereby a fourth annular outermost region 142 of the hollow membrane tubes 112. The fourth annular region 142 radially outside of the third annular region 140, with the fourth annular region having a fourth average flow cross-section area of the hollow membrane tubes that is smaller than the third average flow cross-section area of the third annular region 140.

Optionally a tubular support cage 144 is within the central cavity 114 and optionally an outer tubular support cage 146 surrounds the hollow membrane tubes 112.

The parameters for sizes and types of materials for fibers, end caps can be the same as those described for the first embodiment of FIGS. 2-9.

The fluid transfer element 110 can be incorporated into an assembly 148 which can be interposed as the humidifier shown in FIG. 1. The assembly 148 further comprise a housing 150 defining an element cavity 152 receiving the fluid transfer element 110.

The housing 150 further comprises a first pair of fluid ports 154, 156 with the first flow passageway 122 arranged to flow therebetween. For example, in this embodiment, port 154 is an inlet for dry air and port 156 is for the dry air outlet (that is now at least partly humidified having passed through). Housing also includes a second pair of fluid ports 158, 160 with the second flow passageway 124 arranged to flow therebetween. For example, in this embodiment, port 158 is an inlet for wet discharge gas and port 160 is for the wet air outlet for exhausting to the external environment.

The wet inlet port 158 communicates with an inlet region 162 of the fluid transfer element 110 and the wet outlet port 160 communicates with an outlet region 164 of the fluid transfer element 110. In this embodiment, the inlet region 162 corresponds to the central open cavity 114, However, as noted depending upon whether the design is for radially inward or radially outward flow, inlet region 163 can be the annular chamber 126 surrounding the outer periphery of the outermost annular region 142 of the hollow membrane tubes 112 or instead as shown provided by the central open cavity 114.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Terms of such as “first,” “second,” “third” and the like are used for differentiation only merely to distinguish or identify different members or members of a group; and as such, for example, these terms do not denote any serial limitation, do not denote any sequence limitation and do not denote numerical limitation. For example, if an embodiment sets forth and describes a first collection, a second collection and a third collection, reference in a claim such as a claimed first collection and a claimed second collection could be satisfied by the described first collection and the described second collection, the described first collection and the described third collection, and/or the described second collection and the described third collection.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A fluid transfer element, comprising:
an arrangement of hollow membrane tubes that has:
(a) a first flow passageway defined through the hollow membrane tubes;
(b) a second flow passageway passing separately from the first flow passageway and passing though interstices defined between adjacent members of the hollow membrane tubes, the second flow passageway passing between an inlet region and an outlet region;
wherein the arrangement of the hollow membrane tubes comprises tubes having different flow cross-section areas arranged to provide different flow restriction properties with a first collection of the hollow membrane tubes having a smaller average flow cross-section area than a second collection of the hollow membrane tubes; and
wherein the first collection of the hollow membrane tubes are arranged to be subject to a greater pressure drop along the second flow passageway than the second collection of the hollow membrane tubes.

2. The fluid transfer element of claim 1, wherein the first collection of the hollow membrane tubes are also arranged to be subject to a greater pressure drop along the first flow passageway than the second collection of the hollow membrane tubes.

3. The fluid transfer element of claim 1, further comprising first and second caps into which the hollow membrane tubes are sealingly engaged, wherein intermediate portions of the hollow membrane tubes between the first and second end caps are exposed to the second flow passageway.

4. The fluid transfer element of claim 1, wherein the first collection of the hollow membrane tubes have a first average flow cross-section area that is between 10% and 80% of a second average flow cross-section area of the second collection of the hollow membrane tubes, and more preferably between 20% and 50% of the second average flow cross-section area of the second collection of the hollow membrane tubes.

5. The fluid transfer element of claim 1, wherein the hollow membrane tubes define an inner diameter/width of less than 2 millimeters and preferably between 0.4 millimeter and 1.3 millimeter, and wherein the inner diameter/width of the second collection of the hollow membrane tubes is larger than the inner diameter/width of the first collection of the hollow membrane tubes by at least 0.1 millimeter and preferably between 0.2 millimeter and 0.8 millimeter.

6. The fluid transfer element of claim 1, wherein the hollow membrane tubes having different flow cross-section areas comprise at least three distinct sizes of the hollow membrane tubes.

7. An assembly including the fluid transfer element of claim 1 and further comprising a housing defining an element cavity receiving the fluid transfer element, the housing further comprising:
a first pair of fluid ports with the first flow passageway arranged to flow therebetween, including a first inlet and a first outlet;
a second pair of fluid ports with the second flow passageway arranged to flow therebetween including a second inlet and a second outlet, the second inlet communicating with the inlet region and the second outlet communicating with the outlet region.

8. The assembly of claim 7, wherein the housing comprises a housing body and a removable lid, the lid being removable to allow for replacement of fluid transfer element.

9. The assembly of claim 8, wherein the fluid transfer element is broken up into separate cartridges including a first cartridge and a second cartridge in spaced apart relation, each cartridge having respective spaced apart first and second caps into which respective collections of the hollow membrane tubes are sealingly engaged, wherein the first cartridge comprises the first collection of the hollow membrane tubes and the second cartridge comprises the second collection of the hollow membrane tubes.

10. The assembly of claim 7, wherein the housing comprises a rectangular box-shaped configuration having six sides defining the element cavity, wherein the first inlet and the first outlet are along a single common side of the six sides.

11. The assembly of claim 7, wherein the housing comprises a rectangular box-shaped configuration having six sides defining the element cavity, wherein the second inlet and the second outlet are along a single common side of the six sides.

12. The assembly of claim 7, wherein the housing comprises a rectangular box-shaped configuration having six sides defining the element cavity, wherein each of the first inlet, the first outlet, second inlet and the second outlet are along a single common side of the six sides.

13. The fluid transfer element of claim 1, wherein the arrangement of the hollow membrane tubes surrounds a central open cavity, and further comprising a pair of end caps on opposing ends of the arrangement, one of the end caps having an opening communicating with the central open cavity and wherein the second flow passageway extends radially between the central open cavity and an outer periphery around the arrangement, and wherein the arrangement of hollow membrane comprises sets of hollow membrane tubes having different flow cross-section areas including at least a first annular region and a second annular region.

14. The fluid transfer element of claim 13, wherein the first annular region is radially inside the second annular region with the hollow membrane tubes of the first annular region of a larger average flow cross-section area than the hollow membrane tubes of the second annular region.

15. The fluid transfer element of claim 14, further comprising a third annular region of the hollow membrane tubes radially outside of the second annular region, with the hollow membrane tubes of the third annular region being of a larger average flow cross-section area than the hollow membrane tubes of the second annular region.

16. The fluid transfer element of claim 1, wherein the hollow membrane tubes of the first collection are each of a first common size, and the hollow membrane tubes of the second collection are each of a second common size.

17. A fluid transfer element, comprising:
an arrangement of hollow membrane tubes that has:
(a) a first flow passageway defined through the hollow membrane tubes;
(b) a second flow passageway passing separately from the first flow passageway and passing though interstices defined between adjacent members of the hollow membrane tubes, the second flow passageway passing between an inlet region and an outlet region;
wherein the arrangement of the hollow membrane tubes comprises tubes having different flow cross-section areas; and
wherein the fluid transfer element is provide by multiple cartridges including a first cartridge and a second cartridge in spaced apart relation, each cartridge having respective spaced apart first and second caps into which respective collections of the hollow membrane tubes are sealingly engaged, wherein the first cartridge comprises a first collection of the hollow membrane tubes and the second cartridge comprises a second collection of the hollow membrane tubes, wherein the first collection of the hollow membrane tubes has a smaller average flow cross-section area than a second collection of the hollow membrane tubes.

18. The fluid transfer element of claim 17, wherein the hollow membrane tubes of the first cartridge are all of a common size, and/or the hollow membrane tubes of the second cartridge are all of a common size.

19. The fluid transfer element of claim 17, wherein the first collection of the hollow membrane tubes are also arranged to be subject to a greater pressure drop along the first flow passageway than the second collection of the hollow membrane tubes.

20. The fluid transfer element of claim 17, further comprising first and second caps into which the hollow membrane tubes are sealingly engaged, wherein intermediate portions of the hollow membrane tubes between the first and second end caps are exposed to the second flow passageway.

21. The fluid transfer element of claim 17, wherein each cartridge has a sidewall with a window proximate each end cap communicating the second passageway therethrough.

22. The fluid transfer element of claim 17, wherein the first collection of the hollow membrane tubes have a first average flow cross-section area that is between 10% and 80% of a second average flow cross-section area of the second collection of the hollow membrane tubes, and more preferably between 20% and 50% of the second average flow cross-section area of the second collection of the hollow membrane tubes.

23. The fluid transfer element of claim 17, wherein the hollow membrane tubes define an inner diameter/width of less than 2 millimeters and preferably between 0.4 millimeter and 1.3 millimeter, and wherein the inner diameter/width of the second collection of the hollow membrane tubes is larger than the inner diameter/width of the first collection of the hollow membrane tubes by at least 0.1 millimeter and preferably between 0.2 millimeter and 0.8 millimeter.

24. The fluid transfer element of claim 17, wherein the hollow membrane tubes having different flow cross-section areas comprise at least three distinct sizes of the hollow membrane tubes.

25. The fluid transfer element of claim 17, wherein the hollow membrane tubes of the first collection are each of a first common size, and the hollow membrane tubes of the second collection are each of a second common size.

26. The fluid transfer element of claim 17, wherein the multiple cartridges further includes a third cartridge in spaced relation to the first and second cartridges, with the second cartridge interposed between the first and third cartridges, wherein the third cartridge comprises a third collection of the hollow membrane tubes, wherein the third collection of the hollow membrane tubes has a larger average flow cross-section area than the first and second collections of the hollow membrane tubes.

27. An assembly including the fluid transfer element of claim 17 and further comprising a housing defining an element cavity receiving the fluid transfer element, the housing further comprising:
a first pair of fluid ports with the first flow passageway arranged to flow therebetween, including a first inlet and a first outlet;
a second pair of fluid ports with the second flow passageway arranged to flow therebetween including a second inlet and a second outlet, the second inlet communicating with the inlet region and the second outlet communicating with the outlet region.

28. The assembly of claim 27, wherein the housing comprises a housing body and a removable lid, the lid being removable to allow for replacement of the cartridges of the fluid transfer element.

29. The assembly of claim 27, wherein the housing comprises a rectangular box-shaped configuration having six sides defining the element cavity, wherein the first inlet and the first outlet are along a single common side of the six sides.

30. The assembly of claim 27 wherein the housing comprises a rectangular box-shaped configuration having six sides defining the element cavity, wherein the second inlet and the second outlet are along a single common side of the six sides.

31. A fluid transfer element, comprising:
an arrangement of hollow membrane tubes that has:
(a) a first flow passageway defined through the hollow membrane tubes;
(b) a second flow passageway passing separately from the first flow passageway and passing though interstices defined between adjacent members of the hollow membrane tubes, the second flow passageway passing between an inlet region and an outlet region;
wherein the arrangement of the hollow membrane tubes comprises tubes having different flow cross-section areas; and
a first collection of the hollow membrane tubes and a second collection of the hollow membrane tubes, wherein the first collection of the hollow membrane tubes has a smaller average flow cross-section area than a second collection of the hollow membrane tubes, and wherein the first and second collection of the hollow membrane tubes are arranged in parallel fluid circuit along the second flow passageway.

32. The fluid transfer element of claim 31, further comprising at least one partition wall between the first collection and the second collection.

33. The fluid transfer element of claim 31, wherein the fluid transfer element is provided by multiple cartridges including a first cartridge and a second cartridge, each cartridge having respective spaced apart first and second caps into which respective collections of the hollow membrane tubes are sealingly engaged, wherein the first cartridge comprises the first collection of the hollow membrane tubes and the second cartridge comprises the second collection of the hollow membrane tubes.

34. The fluid transfer element of claim 31, wherein the hollow membrane tubes of the first collection are all of a common size, and/or the hollow membrane tubes of the second collection are all of a common size.

35. The fluid transfer element of claim 31, wherein the first collection of the hollow membrane tubes are also arranged to be subject to a greater pressure drop along the first flow passageway than the second collection of the hollow membrane tubes.

36. The fluid transfer element of claim 31, wherein the second collection of the hollow membrane tubes are arranged to be further downstream along the second flow path relative to the first collection of the hollow membrane tubes.

37. The fluid transfer element of claim 31, further comprising first and second caps into which the hollow membrane tubes are sealingly engaged, wherein intermediate portions of the hollow membrane tubes between the first and second end caps are exposed to the second flow passageway.

38. The fluid transfer element of claim 31, wherein the first collection of the hollow membrane tubes have a first average flow cross-section area that is between 10% and 80% of a second average flow cross-section area of the second collection of the hollow membrane tubes, and more preferably between 20% and 50% of the second average flow cross-section area of the second collection of the hollow membrane tubes.

39. The fluid transfer element of claim 31, wherein the hollow membrane tubes define an inner diameter/width of less than 2 millimeters and preferably between 0.4 millimeter and 1.3 millimeter, and wherein the inner diameter/width of the second collection of the hollow membrane tubes is larger than the inner diameter/width of the first collection of the hollow membrane tubes by at least 0.1 millimeter and preferably between 0.2 millimeter and 0.8 millimeter.

40. The fluid transfer element of claim 31, wherein the hollow membrane tubes having different flow cross-section areas comprise at least three distinct sizes of the hollow membrane tubes.

41. The fluid transfer element of claim 31, further comprising a third collection of the hollow membrane tubes, wherein the third collection of the hollow membrane tubes has a larger average flow cross-section area than the first and second collections of the hollow membrane tubes.

42. The fluid transfer element of claim 41, wherein the third collection is arranged in parallel fluid circuit with the first and second collections.

43. An assembly including the fluid transfer element of claim 31 and further comprising a housing defining an element cavity receiving the fluid transfer element, the housing further comprising:
a first pair of fluid ports with the first flow passageway arranged to flow therebetween, including a first inlet and a first outlet;
a second pair of fluid ports with the second flow passageway arranged to flow therebetween including a second inlet and a second outlet, the second inlet communicating with the inlet region and the second outlet communicating with the outlet region.

44. The assembly of claim 43, wherein the housing comprises a housing body and a removable lid, the lid being removable to allow for replacement of the first and second collections of the fluid transfer element.

45. The assembly of claim 44, wherein the housing comprises a rectangular box-shaped configuration having six sides defining the element cavity, wherein the first inlet and the first outlet are along a single common side of the six sides.

46. The assembly of claim 44 wherein the housing comprises a rectangular box-shaped configuration having six sides defining the element cavity, wherein the second inlet and the second outlet are along a single common side of the six sides.
